(19) United States
(12) Patent Application Publication
(10) Pub. No.: US 2009/0278104 A1
(43) Pub. Date: Nov. 12, 2009

(54) Fence, such as a high visibility animal fence, and method of making

(76) Inventors: Willy Louis Marrecau, Rome, GA (US); David Michael Aspinwall, Marietta, GA (US); Michael Ferringer, Wooster, OH (US)

Correspondence Address: SHLESINGER, ARKWRIGHT & GARVEY LLP, 1420 KING STREET, SUITE 600, ALEXANDRIA, VA, 22314, US

(21) Appl. No.: 12/149,693

(22) Filed: May 7, 2008

(51) Int. Cl. E04H 17/14; B29C 65/08; B29C 65/50

(52) U.S. Cl. 256/45; 256/59; 156/73.1; 156/306.6; 156/324

(57) ABSTRACT

High visibility fence includes an elongated mesh having a length, and a front, back, top, and bottom. Elongated mesh includes vertical stay wires, horizontal line wires, and a strip of synthetic material provided adjacent the front of the mesh. The strip of synthetic material extends horizontally, and a further strip of synthetic material is adjacent the back of the mesh. The further strip of synthetic material overlaps a portion of the strip of synthetic material defining an overlapping region. Strip of synthetic material and further strip of synthetic material extend along the length of mesh and adjacent vertical stay wires. Horizontal further strip of synthetic material is attached to the horizontal strip of synthetic material, and the horizontal strip of synthetic material and the horizontal further strip of synthetic material are attached in overlapping region by an attaching element, such as adhesive, adhesive tape, thermal welding, or ultrasonic welding.

### FIELD OF THE INVENTION

The invention relates to a fence and to a method of making a fence. More specifically, the invention relates to a high visibility fence, such as an animal fence, and a method of making such. Even more particularly, the invention relates to a horse fence with a material, such as an elongated continuous strip of synthetic material, to increase its visibility to horses, and a method of making a horse fence having an elongated continuous strip of synthetic material which is provided during the production of the horse fence.

### BACKGROUND OF THE INVENTION

Fences, such as animal fences, are known, as well as fences particularly suited for animals which need readily visible fences, such as horses. Horses require readily visible fences, as horses have poor eyesight, and are easily startled, and will run into a fence unless it is readily apparent to the startled horse.

It is likewise known how to produce animal fences made of wires by connecting together a number of horizontally extending wires, known as “line wires” with a number of spaced apart vertical wires, known as “stay wires”. Such fences are known in which the vertical stay wires and the horizontal line wires are connected together, such as by providing knots or welds at each intersection of intersecting line wires and stay wires.

It is also known to physically weave the intersecting line wires and stay wires together, such as by wrapping each stay wire around each line wire at each intersection, for example. The term “woven wire” fence is often used, even when the line wires and the stay wires are not physically woven together. For example, even when the wires are connected together by knots or welds at each intersection, the wire fences are frequently termed woven fences.

In the case of animals which require readily apparent fences, such as horses, it is known to erect a number of vertical, spaced apart wooden or metal posts, and then extend a woven metal fence along the spaced apart posts, and attach the woven fence to the posts, such as with nails or staples. Then, in order to increase visibility, a wooden board is attached that extends between the tops of adjacent vertical wooden posts, and is nailed to the posts. It will be appreciated that this type of readily apparent or readily visible fence has expensive components, and is time-consuming and expensive to produce.

Known animal fences are often unsatisfactory for fencing animals requiring high visibility fences, such as horses.

Conventional wooden post and woven metal fences which have a board at the top for enhanced visibility are expensive and time-consuming to install and maintain.

A known snow and sand fence is:

U.S. Pat. No. 4,339,114 Deike.

Known examples of fences, such as animal fences include fences manufactured and sold by NV BEKAERT SA, which can be found at www.bekaertfence.com and www.bekaert.com. BEKAERT fences include smooth wire horse fences such as BEKAERT Horseman® brand wire fences, and BEKAERT Solidlock® brand animal fences. Small animal fences are likewise known.

### OBJECTS AND SUMMARY OF THE INVENTION

It is an object of the invention to overcome the drawbacks of known fences and methods of producing them.

Another object of the invention is to increase the visibility of fences to yield high visibility fences.

A further object of the invention is to provide more cost-effective fences, and methods of making such.

Yet another object of the invention is to provide a method of making a woven metal fence with a one or more rails, or the equivalent of rails, such as an elongated piece of material, which may be an elongated strip of synthetic material, such as a plastic material, in an automated production process.

Another object of the invention is to provide a method of making a woven metal fence with a one or more rails, or the equivalent of rails, in a continuous production process.

Another object of the invention is to provide a method of producing a high visibility fence with a continuous strip or rail of material at one or more locations on the fence, in order to eliminate the need to add one or more rails in a later step, such as in a later on-site installation step in use; e.g., in the field.

Yet another object of the invention is to provide a method of continuously producing a high visibility horse fence which can be made with a factory-installed horse rail, and which can be produced as a finished product and provided as a roll of finished product.

Another object of the invention is to provide a method of producing a high visibility fence without the use of wooden rails and/or without the use of mechanical fasteners, such as nails.

Another object of the invention is to provide a fence that has a longer life, and which requires little or no maintenance, as compared to known fences.

In sum, the inventive high visibility fence includes an elongated mesh having a length, the elongated mesh including a front, a back, a top, and a bottom. The elongated mesh includes substantially vertical stay wires, and substantially horizontal line wires, and a strip of synthetic material is provided adjacent the front of the mesh. The strip of synthetic material extends substantially horizontally, and a further strip of synthetic material is provided adjacent the back of the mesh. The further strip of synthetic material extends substantially horizontally, and the further strip of synthetic material is configured to at least partially overlap a portion of the strip of synthetic material and to define an overlapping region. The strip of synthetic material and the further strip of synthetic material extend along the length of the mesh and extend adjacent the substantially vertical stay wires. The substantially horizontal further strip of synthetic material is attached to the substantially horizontal strip of synthetic material, and the substantially horizontal strip of synthetic material and the substantially horizontal further strip of synthetic material are attached in the overlapping region by an attaching element.

Further, the inventive fence includes a high visibility fence in which the attaching element includes a weld.

The weld may likewise be an ultrasonic weld.

An attaching element, such as an adhesive or adhesive tape, may be used in addition to or instead of a weld.

The invention likewise includes a method of making a high visibility fence.

The inventive method of making a high visibility fence includes:
a) providing an elongated mesh having a length, the mesh including a front, a back, a top, and a bottom, and the elongated mesh including substantially vertical stay wires, and substantially horizontal line wires;
b) providing a strip of synthetic material on the front of the mesh, and the strip of synthetic material extending substantially horizontally;
c) providing a further strip of synthetic material on the back of the mesh, the further strip of synthetic material extending substantially horizontally, and the further strip of synthetic material being configured to at least partially overlap a portion of the strip of synthetic material and to define an overlapping region;
d) the strip of synthetic material and the further strip of synthetic material extending along the length of the mesh and extending adjacent the substantially vertical stay wires;
e) attaching the substantially horizontal further strip of synthetic material to the substantially horizontal strip of synthetic material; and
f) the substantially horizontal strip of synthetic material and the substantially horizontal further strip of synthetic material being attached in the overlapping region.

The inventive method likewise includes that the attaching in the overlapping region is performed by welding, such as ultrasonic welding or thermal welding, for example. Other attaching elements, such as adhesives, glues, and adhesive tape, including double-sided tape may be used in addition to or instead of welding.

It will be appreciated that relative terms such as up, down, vertical, horizontal, left, and right, are for convenience only and are not intended to be limiting.

### BRIEF DESCRIPTION OF THE DRAWINGS

FIG. 1 is a front elevational view of an embodiment of a fence according to the invention; and

FIG. 2 is an enlarged rear elevational view of a portion of the fence of FIG. 1;

FIG. 3 is a sectional view of the fence of FIG. 1, taken along line 3-3 in FIG. 2;

FIG. 4 is an enlarged rear elevational view of a portion of another embodiment of a fence according to the invention, the view being similar to FIG. 2;

FIG. 5 is a sectional view of the fence of FIG. 4, taken along line 5-5 in FIG. 4;

FIG. 6 is a front elevational view of a portion of another embodiment of a fence according to the invention;

FIG. 7 is a front elevational view of a portion of a further embodiment of a fence according to the invention;

FIG. 8 is a front elevational view of a portion of another embodiment of a fence according to the invention;

FIG. 9 is a schematic front elevational view of an embodiment of a method of making a fence according to the invention;

FIG. 10 is a schematic front elevational view of another embodiment of a method of making a fence according to the invention;

FIG. 11 is a front perspective view of a further embodiment of a method of making a fence according to the invention;

FIG. 12 is a front perspective view of a portion of another embodiment of a method of making a fence according to the invention;

FIG. 13 is a front elevational view of a portion of another embodiment of a fence according to the invention;

FIG. 14 is a front elevational view of a portion of a further embodiment of a fence according to the invention;

FIG. 15 is a front elevational view of a portion of another embodiment of a fence according to the invention;

FIG. 16 is a front elevational view of a still further embodiment of a fence according to the invention; and

FIG. 17 is a front elevational view of another embodiment of a fence according to the invention.

### DETAILED DESCRIPTION OF THE INVENTION

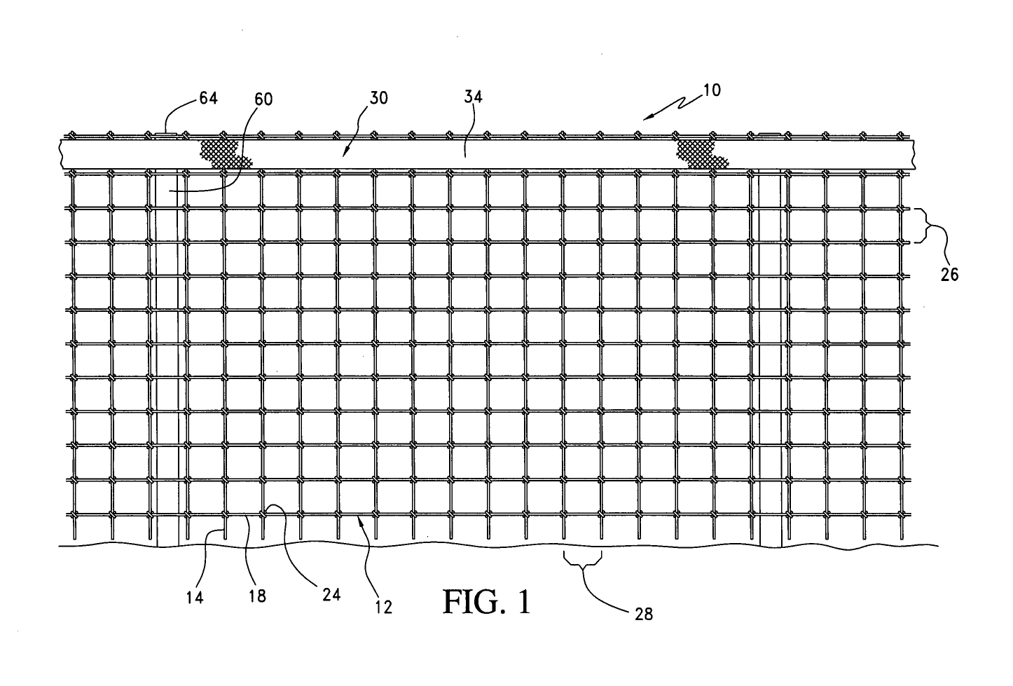

FIGS. 1-3 illustrate an embodiment of a fence, such as the illustrated high visibility fence 10, according to the invention.

High visibility fence 10 may include a mesh 12, such as a woven wire mesh, including a number of substantially vertically extending stay wires 14, and a number of transversally extending line wires 18, as shown. Stay wires 14 and line wires 18 may be attached at their intersections by an attachment 24. Attachment 24 may be a knot, as shown.

Further, attachment 24 may be a weld in a case where stay wires 14 and line wires 18 are metal wires, for example. Line wires 18 may be spaced apart at a distance or a spacing 26, and stay wires 14 may be spaced apart at a distance or a spacing 28. The size of spacings 26 and 28 will be determined by the type of animal, for example, to be kept in or out, for example, and the intended use.

High visibility fence 10 may further include a rail 30, which may be in the form of a continuous strip or sheet of material, such as an elongated piece of plastic material. As will be explained in greater detail below, rail 30, may be made of material which has a greater degree of visibility to a mammal, such as a domestic animal including horses and cows, for example, than the mesh 12, for example. In this manner, the animal is more likely to see and to be aware that high visibility fence 10 is in place. Thus, the animal is less likely to strike the fence when the animal is moving under normal conditions or indeed startled.

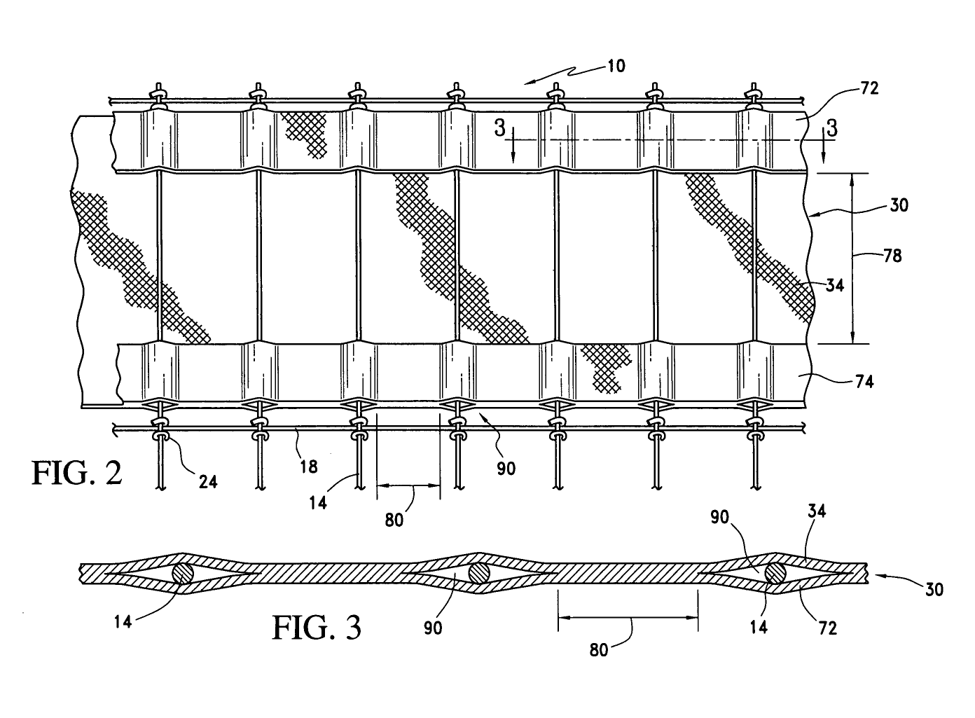

In use, a number of posts 60 will typically be provided that extend substantially vertically from the ground, for example, and include respective tops 64. As shown in greater detail in FIGS. 2 and 3, rail 30 may include a front sheet 34 and two or more rear sheets or strips 72 and 74. As shown, rear strip 72 may be provided adjacent the top of front sheet 34, and rear strip 74 may be provided at the bottom of sheet 30. Top rear strip 72 and bottom rear strip 74 may be spaced apart at a distance 78, depending on the intended use.

In order to secure rail 30 at a desired location on mesh 12, rear strips 72 and 74 may be attached to front strip 34 at one or more attachment regions 80. In this embodiment, attachment region 80 is provided as a welding region 80 in which region top rear strip 72 may be welded to front strip 34 by a sonic welding process, such as an ultrasonic welding process, to produce an ultrasonic weld in welding region 80. In such a case, front strip 34 and rear strip 72 and 74 will be made of materials, such as synthetic materials of the type which may be welded together by ultrasonic welding. The welding may be accomplished by a conventional ultrasonic welding device, as described below, and as will be readily apparent to a person having ordinary skill in the art.

Further, a gap 90 may be provided between vertical stay wire 14 and welding region 80, as shown in FIGS. 2 and 3. Gap 90 may be sized and configured so that, in use, there is sufficient movement or “play” possible between stay wire 14 and welding region 80 to ensure that when forces act on fence 10, the weld in welding region 80 is less likely to be broken than would be the case when too much “play” or too little “play” were provided. Still further, gap 90 may be sized and configured so that it is sufficiently large to prevent water and moisture from collecting adjacent stay wire 14, in use, in the case where high visibility fence 10 has been rained on. Gap 90 may likewise be sized and configured so that there will be no water or moisture buildup adjacent line wires 18 and/or attachments 24.

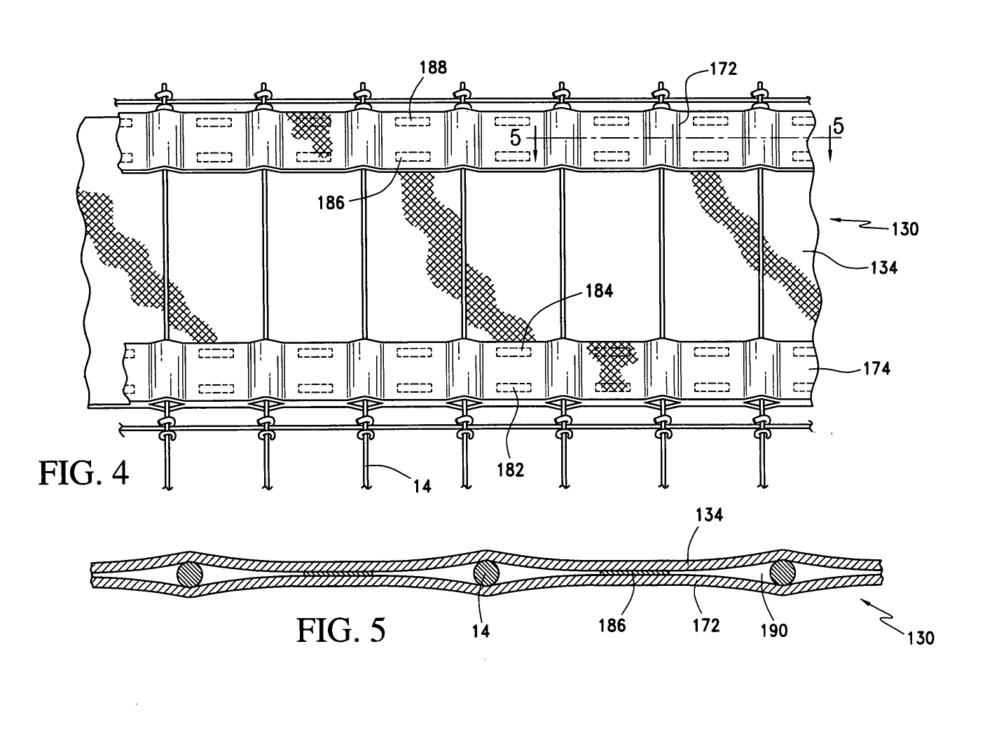

FIGS. 4 and 5 illustrate another embodiment of fence 130, shown as a high visibility fence, according to the invention.

High visibility fence 130 may likewise be provided with a front strip of synthetic material 130, which may serve as a readily visible rail visible to animals, in use, as well as an upper rear strip of material 172 and a lower rear strip of material 174. Rear strips 172 and 174 may be spaced apart near the top and the bottom of front strip 130, and attached thereto. The attachment of lower rear strip 174 to front strip 130 may be made by use of one or more attaching elements 182, 184. Attaching elements of 182, 184 may be in the form of an adhesive or a piece of adhesive tape, such as a piece of double-sided adhesive tape. Adhesive 182, as well as adhesive 184, in a case where two adhesive attachments are used, may be provided manually or by machine during the production process, as will be readily appreciated.

Top rear strip 172 may likewise be secured to front strip 130 by one or more attaching elements, such as the illustrated adhesive attachments 186 and/or 188, one or both of which may be in the form of an adhesive, an adhesive tape, and a piece of double-sided adhesive tape, for example.

There may be a gap 190 provided between stay wire 14, top rear strip 172, front strip 134, and attachment element 186, for example. As will be appreciated, gap 190 may be sized and configured so that, in use, there is sufficient movement between stay wire 14 and attaching elements 182, 184 to ensure that when forces act on fence 130, the attachment is less likely to be broken than would be the case if too much or too little movement were provided. In a manner analogous to the embodiment of FIGS. 1-3, gap 190 of FIGS. 4 and 5 may be sized and configured so that it is sufficiently large to prevent water and moisture from collecting adjacent to stay wires 14, line wires 18, and/or attachments 24 in use, such as when high visibility fence 130 has been subjected to spray irrigation or rain.

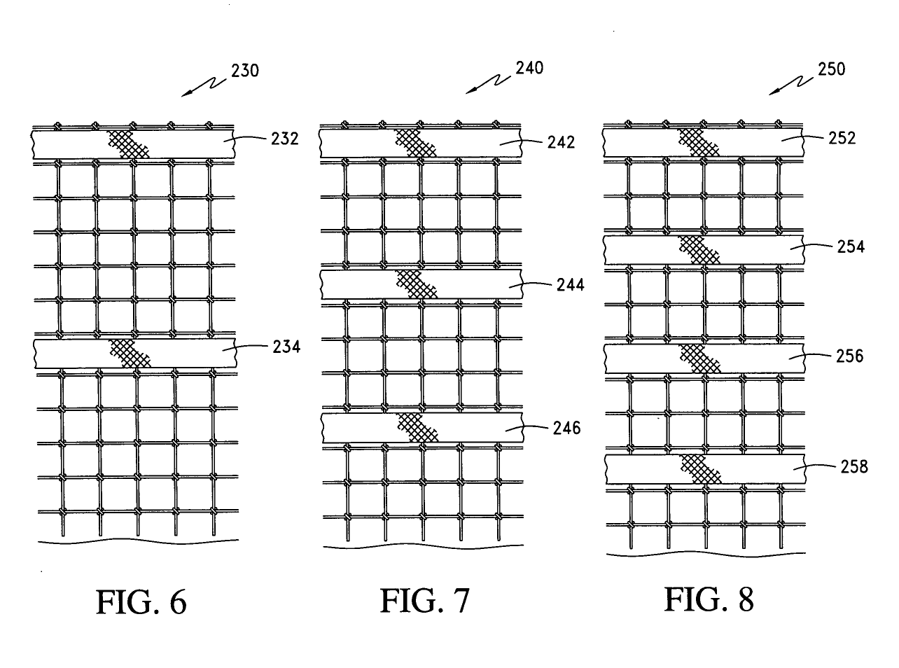

FIG. 6 illustrates another embodiment of a high visibility fence 230 according to the invention. Fence 230 may be provided with an upper rail 232 and a lower rail 234, and high visibility fence 230 is suitable for use in cases where a two-rail fence is desired. As will be readily appreciated, such a two-rail fence may be used in the case where two different types of animals are being fenced in or out, as well as in the case where enhanced visibility may be provided by having a pair of spaced apart rails; i.e. upper rail 232 and lower rail 234.

FIG. 7 illustrates another embodiment of a high visibility fence 240 according to the invention that includes an upper rail 242, a middle rail 244, and a lower rail 246.

FIG. 8 illustrates yet another preferred embodiment of a high visibility fence 250 according the invention in which four spaced apart rails are provided; i.e. an upper rail 252, two middle rails 254 and 256, and a lower rail 258. Again, it will be appreciated that high visibility fence 250 will be suited for use in locations where even greater visibility is desired; and, indeed, in cases where the user prefers having four rails.

In each of the embodiments of FIGS. 6-8, it will appreciated that the various rails may be made of synthetic materials as described in connection with the embodiments of FIGS. 1-5, and each of the rails may be attached by any of the different above-described attachments, such as by thermal welds, ultrasonic welds, adhesives, and adhesive tapes.

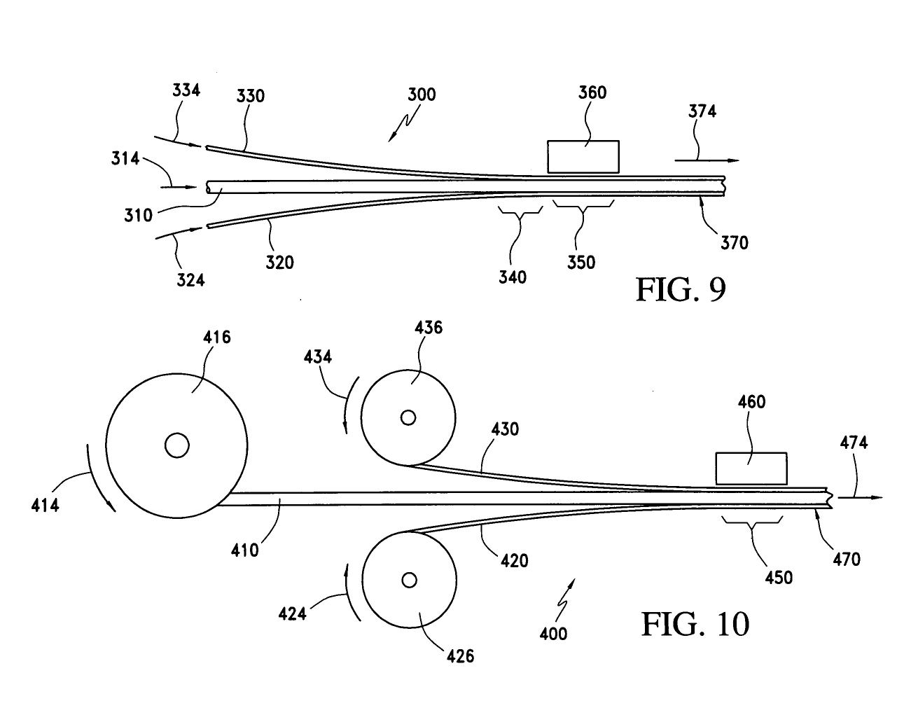

FIG. 9 illustrates an embodiment of a method 300 for making a high visibility fence according to the invention.

Method 300 may include providing an elongated mesh 310 in the production process in a direction 314, as shown. In addition, a strip of material 320, such as a lower strip 320 of synthetic material may be provided in a direction 324 on a lower side of mesh 310 as shown in FIG. 9. A further strip of material 330, such as an upper strip 330 of synthetic material, may likewise be provided in a direction 334. Upper and lower strips of synthetic material 330 and 320, respectively, may be aligned and located relative to mesh 310 in an alignment region 340, as shown.

A welding unit 360, such as an ultrasonic welding unit 360, such as would be readily understood by a person having ordinary skill in the art, may be provided in a welding region 350. During production of a high visibility fence in accordance with method 300, after alignment in alignment region 340, the materials, that is mesh 310, lower rail 320, and upper rail 330 are advanced to welding region 350, and the upper and lower strips of synthetic material 330 and 320 are welded together at desired locations by welding unit 360. Then, a finished product 370; i.e. desired a high visibility fence exits the production process in a direction 374.

It will be appreciated that mesh 310 may be produced from stay wires and vertical wires woven together during the same production process as shown in method 300. In that manner, mesh 310 will have never been previously rolled up in a roll, or otherwise stored, and there will be, hence, no inherent pre-tensioning of mesh 310 during the production process of method 300. In that manner, the finished product 370 may be exited in direction 374 and, for example, rolled up in an unillustrated roll of completed, finished high visibility fence for the first time. This use of mesh 310 produced on site and never pre-rolled, may be used to enhance the consistency of the finished high visibility fence.

FIG. 10 illustrates another embodiment of a method 400 according to the invention.

In accordance with method 400, the materials used in the production of a high visibility fence, such as the high visibility fence of FIGS. 1-3, for example, will be as follows.

A lower strip of material 420 is provided in a direction 424 from a roll 426 of, for example, synthetic material, such as a plastic.

A mesh, such as a woven wire mesh 410, is provided in a direction 414 from a roll 416 of mesh 410.

Further, an upper strip of substantially continuous material 430, such as a synthetic material, is provided in a direction 434 from a rail 436.

Again, a welding region 450 is provided at which region 450 a conventional welding unit, such as an ultrasonic welding unit 460, may be used to weld upper and lower strips of material 420 and 430 together at desired welding regions, such as illustrated by welding regions 80 of the embodiment of FIGS. 1-3. A finished product 470 in the form of a high visibility fence, for example, will result and will exit this part of the production process in a direction 474 for further working, such as by rolling the finished high visibility fence up into rolls of a desired length of finished product.

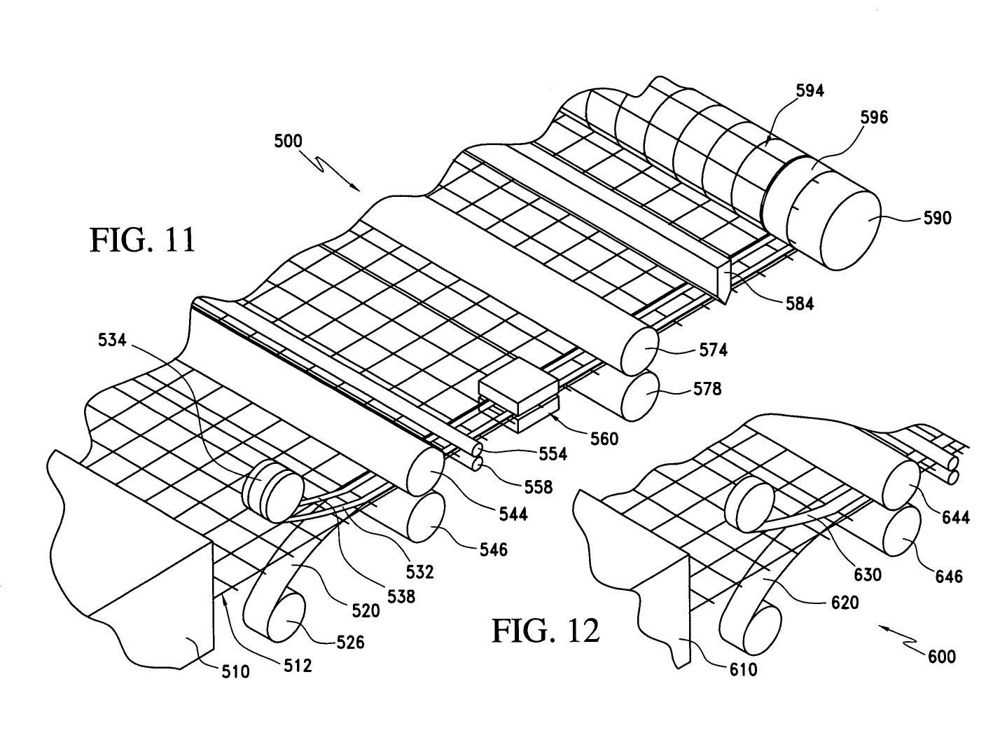

FIG. 11 illustrates another embodiment of a method 500 for producing a high visibility fence according to the invention.

Production method 500 includes providing a mesh production unit 510, such as a woven wire mesh production unit 510 for producing a mesh 512 on site during production process 500. Further, a front strip 520 may be provided from a roll 526 of material for providing a continuous front rail, a further roll of material 534 may be used for providing both an upper rear strip of material 532 and a lower strip of material 538 on the rear of mesh 512 and located so that each of the strips of material 520,532, and 538 are provided in a desired position relative to each other.

Then, one or more advancing and/or alignment rollers 544 and 546 may be provided to ensure that each of the strips of material 532, 538, and 520 is advanced and aligned in a desired manner relative to each other. Further, one or more tensioning elements, such as illustrated tensioning rollers 554 and 558, may be provided on opposite sides of the mesh 512 with strips 532, 538, and 520 thereon for ensuring that, for example, strips 532 and 538 are held in a manner so that a welding unit, such as a conventional ultrasonic or thermal welding unit 560 may provide the proper weld(s) in a desired manner.

As needed, one or more advancing units, such as the illustrated advancing rollers 574 and 578 may be used to further tension and advance the welded material. Likewise, a cutting device, such as the illustrated severing unit 584 may be used to cut off a desired length of finished high visibility fence 594 which is being rolled up on a roller 590, as shown. The finished high visibility fence 594 will thus include the finished high visibility strip or rail of material 596 at the top thereof, such as in the embodiment of FIGS. 1-3, for example.

FIG. 12 illustrates another embodiment of a method 600 for producing a high visibility fence.

As shown, a mesh feed unit 610, or a mesh production unit 610 in the case where the mesh is produced on site, advances a mesh from the left to the upper right of the drawing, in a manner analogous to that shown in FIG. 11. In this production method 600, a front strip of material 620 is provided in a substantially continuous manner and a further rear strip of material 630 is likewise provided concurrently on the other side of the mesh in a manner analogous to the embodiment of FIG. 11. Likewise, advancing and alignment devices, such as the illustrated advancing rollers 644 and 646 may be used to advance the materials in the production process 600. Although un-illustrated, it will be readily understood that the thus advanced respective front and rear strips of material 620 and 630 may be secured together by ultrasonic welding or by a different type of attachment, such as by gluing, adhering with an adhesive, or attaching with pieces of adhesive tape, such as double-sided adhesive tape, as described above.

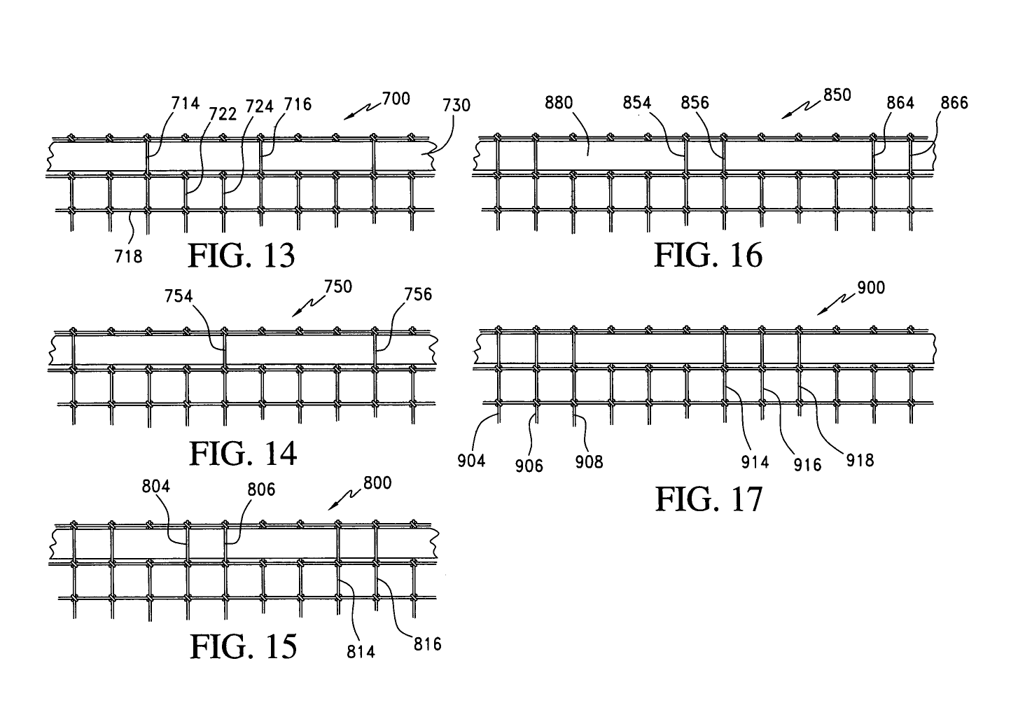

FIG. 13 illustrates another embodiment of a fence 700 according to the invention.

Hence 700 is a high visibility fence including a number of line wires 718, and a number of spaced apart stay wires 714, 716, 722, and 724. In this embodiment, an upper high visibility strip of material 300 which serves as a rail, is woven over and under respective ones of the stay wires. As shown in this embodiment, a strip of material 730 is woven under stay wire 714, then extends over the next two stay wires 722,724, and then is woven under the next following stay wire 716. This weaving process of weaving under one stay wire and then over the next two adjacent stay wires before weaving under the fourth stay wire 716, and so forth, may be used to eliminate the need for a rear strip of material attached to the front strip of material, as in the embodiments of FIGS. 1-12.

FIG. 14 illustrates another embodiment of a fence 750, such as a high visibility fence, and which includes a feature that a strip of material 730 defining the upper rail is woven over, that is extends over three stay wires, then is woven under the fourth stay wire 754, and again extends over three stay wires before extending under another fourth stay wire 756.

FIG. 15 illustrates yet another embodiment of the invention in which the strip of material 730 used to enhance the visibility of fence 800 extends under two stay wires then over a next adjacent stay wire, then under two stay wires, such as the illustrated stay wires 804 and 806, then over two stay wires, then under two stay wire 814 and 816, then over one stay wire, and so forth in a repeating pattern of under two, over one, under two, over two, under two, over one, under two, over two, and so forth.

FIG. 16 illustrates another embodiment of a high visibility fence 850 according to the invention in which an upper rail 880 may be woven so as to extend under two stay wires, then over three stay wires, then under two stay wires, such as the illustrated stay wires 854 and 856, then over three stay wires, then under two stay wires 864 and 866, then again over three stay wires, in a likewise repeating pattern.

FIG. 17 illustrates another embodiment of a high visibility fence 900 in which the strip of material enhancing the visibility of fence 900 extends under three stay wires, such stay wires 904, 906, 908, then over three stay wires, then under three stay wires 914, 916, and 918, then again over three stay wires, and under three stay wires, and so forth in a desired repeating pattern.

It will be appreciated that in each of the embodiments of FIGS. 13-17, the material of the strips 730 and 880, for example, will be selected so as to flex sufficiently during the production process so that the strips of material may be woven over and under the stay wires without detrimental bending of the strip of material that damages the strip of material. Indeed, it may be desirable, depending on the intended use, that the strip of material 730, for example, be selected so that it is of a sufficient size, thickness, flexibility, weatherability, for example, so that the stay wires not be readily visible to a user, in use, in order to enhance the visual appearance of the various fence embodiments of FIGS. 13-17.

It is contemplated that any suitable materials be used in accordance with the invention. For example, the strips of material used at the top of the fence for the front strip of material, for example, may have a width of about 4-6.5 inches, and in the case where two thinner rear strips are used at the top and bottom of the front strip of material to secure it to the fence, the two thinner rear strips may be about 1 inches in width, for example. A space between the two thinner strips in such case may be about 2-4.5 inches in the case where the front strip of material, for example, has a width of about 4-6.5 inches. In the case where a single rear strip is used to secure a front strip of 4-6.5 inches in width, the width of the single rear strip of material may be about 1-2 inches or more.

The plastic material for the front and rear strips of material may include conventional ultraviolet-resistant, weather-resistant, and/or heat-resistant materials, in any variety of colors, such as white, brown, red, blue, and other desired colors. Mildew-resistant materials may likewise be used depending on the intended use and local geography.

When welding plastics, such as may be used for the synthetic strip materials, the materials typically have similar melting temperatures, and vibrations are introduced in the welding region, as shown and described above. A known ultrasonic welding process may be used for welding polymers.

Hot gas welding, such as hot air welding, may be used to join together a variety of plastics, such as the strips of synthetic material according to the invention.

Typically, the two or more strips of synthetic material being joined together by hot air welding will both be the same type of plastic. For example, two like polymer sheets, such as polyvinyl chloride (PVC) sheets, may be welded together at desired locations by hot air welding. Other plastics, such as polyurethane may likewise be used, as will be readily appreciated by a person having ordinary skill in the art.

Further, pressure members, such as two opposed pressure members located on opposed sides of the two plastic materials to be welded, may be used to physically bring together and apply pressure at a desired contact area of the two sheets of synthetic material at which contact area the weld will be formed. One or both of the pressure members may have a contact surface which has the same geometry as the geometry of the weld to be made, as will be readily appreciated. One or both of the pressure members may be moved relative to the other pressure member, as will be readily apparent.

Radio frequency welding, sonic, and ultrasonic welding, for example, may likewise be used to join together the two or more sheets of synthetic material. There are additional adhering, welding, and fusing processes and products which may likewise be used, as will be readily apparent.

Further material for the synthetic strips may include polyurethane strips or sheets, for example. Also, polyvinyl chloride coated fabrics and polyurethane coated fabric may be used, depending on the intended use, strength and weather-resistance required, and/or the type of welding or fusing that can be performed sufficiently quickly during the production phase and/or will provided an end product (i.e., finished fence) with the desired characteristics.

For example, a strip material may be used which includes, high abrasion resistance, UV protection, and cold and hot weather durability. The strip material fabric and coatings may be varied depending on the climate and intended use. The strip material may be made of a polyester fabric with an abrasion-resistant polymer coating, which may be thermally and/or ultrasonically welded, that meets these climate and durability requirements.

Other attaching elements in addition to adhesives are contemplated, such as staples, metal rings, and the like.

The elongated mesh may be sized and configured as a small animal mesh, and/or as a known no-climb animal mesh.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1-7. (canceled)

8. A high visibility fence as in claim 29, wherein:
a) the elongated mesh includes a woven wire mesh.

9. A high visibility fence as in claim 29, wherein:
a) the elongated mesh is sized and configured as a small animal mesh.

10-18. (canceled)

19. A high visibility fence as in claim 8, wherein:
a) the synthetic material includes polyvinyl chloride.

20. A high visibility fence as in claim 29, wherein:
a) the synthetic material includes polyvinyl chloride.

21. (canceled)

22. (canceled)

23. A high visibility fence as in claim 29, wherein:
a) the top rail extends under an adjacent vertical stay wire, and then extends over a next two adjacent vertical stay wires.

24. A high visibility fence as in claim 29, wherein:
a) the top rail extends under an adjacent vertical stay wire, and then extends over a next three adjacent vertical stay wires.

25. A high visibility fence as in claim 29, wherein:
a) the top rail extends over a next tow adjacent vertical stay wires, and then extends under a next two adjacent vertical stay wires.

26. A high visibility fence as in claim 29, wherein:
a) the top rail extends over a next three adjacent vertical stay wires, and then extends under a next one adjacent vertical stay wires.

27. A high visibility fence as in claim 29, wherein:
a) the top rail extends over a next three adjacent vertical stay wires, and then extends under a next two adjacent vertical stay wires.

28. A high visibility fence as in claim 29, wherein:
a) the synthetic material includes a polyester fabric with an abrasion-resistant polymer coating.

29. A high visibility fence, comprising:
a) an elongated mesh having a length, the elongated mesh including a front, a back, a top, and a bottom;
b) the elongated mesh including substantially vertical stay wires, and substantially horizontal line wires;
c) a top, high visibility rail, the top rail being provided adjacent the top of the mesh, and the top, high visibility rail extending substantially horizontally;
d) a lower, high visibility rail, the lower rail being provided spaced apart from the top of the mesh, the lower, high visibility rail extending substantially horizontally, the lower, high visibility rail being spaced apart from the top rail, and the lower rail being spaced apart from the high visibility top rail toward the bottom of the mesh;
e) the top, high visibility rail and the lower high visibility rail being made of synthetic material highly visible to an animal having poor eyesight;
f) the top, high visibility rail and the lower high visibility rail being made of synthetic material having a greater degree of visibility to an animal than the mesh, so that the animal is more likely to see and to be aware that the high visibility fence is in place;
g) the substantially horizontal top, high visibility rail and the substantially horizontal lower high visibility rail extending along the length of the mesh and extending adjacent the substantially vertical stay wires; and
h) the top, high visibility rail extending over and under the substantially vertical stay wires, so that the top rail is woven over and under respective ones of the substantially vertical stay wires; and
i) the lower rail being spaced apart and lower than the top rail, and the lower rail extending over and under the substantially vertical stay wires, so that the lower rail is woven over and under respective ones of the substantially vertical stay wires.
